(19) United States
(12) Patent Application Publication
(10) Pub. No.: US 2010/0021716 A1
(43) Pub. Date: Jan. 28, 2010

(54) THERMAL BARRIER SYSTEM AND BONDING METHOD

(76) Inventors: Christopher W. Strock, Kennebunk, ME (US); George H. Reynolds, Sanford, ME (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/764,888

(22) Filed: Jun. 19, 2007

(51) Int. Cl. B32B 18/00; C04B 37/00

(52) U.S. Cl. 428/312.6; 428/426; 428/428; 428/432; 428/332; 65/36; 65/43

(57) ABSTRACT

A composite article includes a substrate, a ceramic member on the substrate and a ceramic bond coat for securing the substrate and the ceramic member together. A method of securing the ceramic member and the substrate together includes pyrolyzing a ceramic precursor, such as a ceramic powder, between the substrate and the ceramic member to form the ceramic bond coat.

### BACKGROUND OF THE INVENTION

This invention relates to protective thermal barriers and, more particularly, to abradable ceramic barrier systems and methods of bonding to a substrate.

Components that are exposed to high temperatures, such as a component within a gas turbine engine, typically include protective coatings. For example, components within a gas turbine engine such as combustor liners, turbine blades, turbine vanes, and blade outer air seals typically include one or more coating layers that protect the component from erosion, oxidation, corrosion or the like to thereby enhance durability or maintain efficient operation of the engine. In particular, some conventional outer air seals include a relatively abradable ceramic coating that contacts relatively abrasive tips of the turbine blades during engine operation such that the blades abrade the coating upon operation of the engine. The abrasion between the coating and the blade tips provides a minimum clearance between these components such that gas flow around the tips of the blades is reduced to thereby maintain engine efficiency. Typically, the coating is formed using a thermal spray process or the like to deposit and securely bond the coating on the component.

One drawback of the abradable ceramic coating is its vulnerability to erosion and spalling. For example, spalling may occur as a loss of portions of the coating that detach from the component. Loss of the coating increases clearance between the outer air seal and the blade tips and is detrimental to turbine engine efficiency. One cause of spalling is the elevated temperature within the turbine section, which can cause sintering of the ceramic coating. The sintering causes the coating to shrink, which produces stresses between the coating and the component. If the stresses are great enough, the coating may delaminate and detach from the component.

One proposed solution for improving spalling and delamination resistance is to use a ceramic composite having a higher thermal resistance than a typical ceramic coating such that the ceramic material does not reach its sintering temperature during engine operation. One potential hurdle to using the ceramic composite is that it may have a relatively complex composite architecture that may preclude forming the ceramic composite directly on the substrate, such as by using the thermal spray process that is used for the ceramic coating.

Accordingly, there is a need for a thermal barrier system having enhanced thermal resistance and a method for bonding the thermal barrier system to a component.

### SUMMARY OF THE INVENTION

An example composite article includes a substrate, a ceramic member on the substrate and a ceramic bond coat for securing the substrate and a ceramic member together. For example, the ceramic member comprises a first pyrolysis temperature, and the ceramic bond coat comprises a second pyrolysis temperature that is less than the first pyrolysis temperature.

In manufacturing the composite article, an intermediate is formed and includes the substrate, the ceramic member on the substrate, and a ceramic precursor between the substrate and the ceramic member. For example, the ceramic precursor is a ceramic powder slurry.

An example method of securing the ceramic member to the substrate includes the step of pyrolyzing a ceramic precursor between the substrate and the ceramic member to form the ceramic bond coat.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 illustrates an example gas turbine engine.

FIG. 2 illustrates a turbine section of the gas turbine engine.

FIG. 3 illustrates a portion of a seal member within the turbine section.

FIG. 4 illustrates the seal member with an optional bond coat.

FIG. 5 illustrates an example method for securing a ceramic member to a substrate.

### DETAILED DESCRIPTION OF THE PREFERRED EMBODIMENT

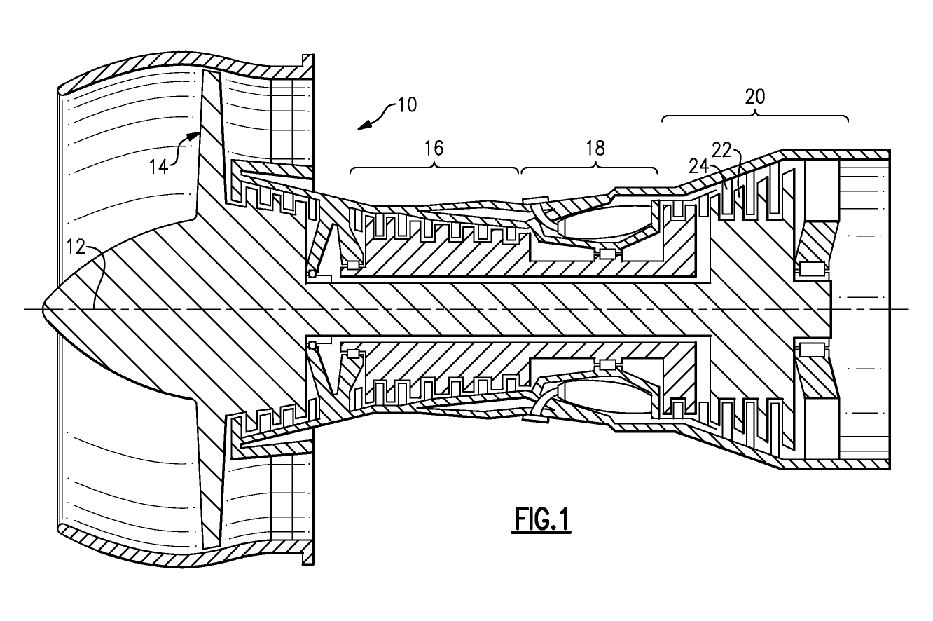

FIG. 1 illustrates selected portions of an example gas turbine engine 10, such as a gas turbine engine 10 used for propulsion. In this example, the gas turbine engine 10 is circumferentially disposed about an engine centerline 12. The engine 10 includes a fan 14, a compressor section 16, a combustion section 18 and a turbine section 20 that includes turbine blades 22 and turbine vanes 24. As is known, air compressed in the compressor section 16 is mixed with fuel and burned in the combustion section 18 to produce hot gases that are expanded in the turbine section 20. FIG. 1 is a somewhat schematic presentation for illustrative purposes only and is not a limitation on the disclosed examples. Additionally, there are various types of gas turbine engines, many of which could benefit from the examples disclosed herein, which are not limited to the design shown.

FIG. 2 illustrates selected portions of the turbine section 20. The turbine blade 22 receives a hot gas flow 26 from the combustion section 18 (FIG. 1). The turbine section 20 includes a blade outer air seal system 28 having a seal member 30 that functions as an outer wall for the hot gas flow 26 through the turbine section 20. The seal member 30 is secured to a support 32, which is in turn secured to a case 34 that generally surrounds the turbine section 20. For example, a plurality of the seal members 30 are circumferentially located about the turbine section 20.

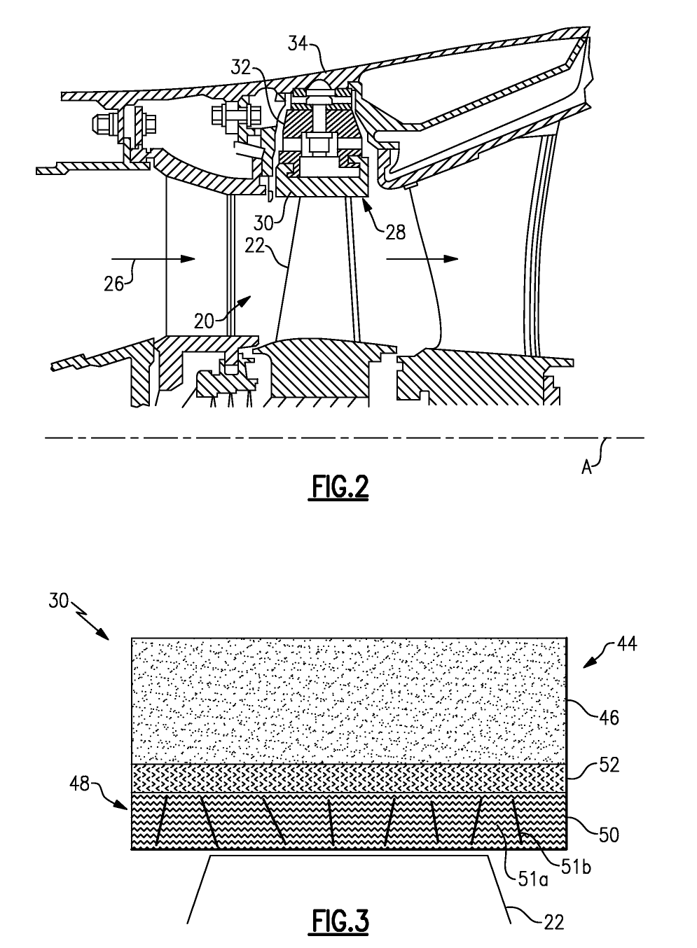

FIG. 3 illustrates an example portion 44 of the seal member 30. In this example, the seal member 30 includes a substrate 46 having a thermal barrier system 48 disposed thereon. The thermal barrier system 48 includes an abradable ceramic member 50, such as a ceramic matrix-ceramic fiber composite, and a ceramic bond coat 52 between the ceramic member 50 and the substrate 46. Although a particular thermal barrier system 48 is shown, it is to be understood that the disclosed examples are not limited to the illustrated configuration and may include additional layers. Furthermore, although the seal member 30 is shown, it is to be understood that the disclosed examples may also be applied to other types of engine or non-engine components.

Optionally, as illustrated in FIG. 4, the thermal barrier system 48 additionally includes a bond coat 54 (or other suitable material, e.g., aluminides, Ni chrome as is known in the art) between the ceramic bond coat 52 and the substrate 46 to provide a desired roughness for bonding. The bond coat 52 may include MCrAlY, where the M is at least one of nickel, cobalt, iron, or a combination thereof, Cr is chromium, Al is aluminum, and Y is yttrium and may include other oxygen active elements. Alternatively, the bond coat includes nickel and chrome, or nickel, chrome, and aluminum.

In the disclosed example, the ceramic bond coat 52 includes at least one of zirconia, zirconia silicate, alumina, or mullite. Given this description, one of ordinary skill in the art will recognize other types of ceramic materials that may be used.

The ceramic member 50 is a pre-formed and pre-sintered separate piece that is then secured to the substrate 46 using the ceramic bond coat 52. For example, the ceramic member 50 is a pre-formed ceramic matrix composite, such as a composite having a ceramic matrix 51a and ceramic fibers 51b dispersed within the ceramic matrix 51a. The ceramic member 50 may comprise other types of ceramic structures, such as closed cell foams described in U.S. patent application Ser. No. 11/755,281 or other porous structures. In one example, the ceramic matrix 51a comprises yttria stabilized zirconia (e.g., 7 wt % yttria stabilized zirconia), hafnia, zirconia, gadolinia, mullite, alumina, or combinations thereof. The ceramic fibers 51b comprise yttria stabilized zirconia, hafnia, zirconia, gadolinia, mullite, alumina, or combinations thereof disbursed through the ceramic matrix. In a further example, the hafnia, zirconia, or gadolinia of the disclosed examples is selected from a composition disclosed in U.S. Pat. No. 6,284,323 or U.S. Pat. No. 6,924,040.

The thickness of the ceramic member 50 may vary, depending on the desired level of thermal resistance required and amount of space available in the engine 10. In one example, the thickness of the ceramic member is about 100 mils (2.54 mm) or less. In a further example, the thickness is between about 10 mils (0.25 mm) and 75 mils (1.91 mm). However, in other examples, the thickness may be 0.25 inches (6.25 mm) or 0.75 inches (19 mm), or greater.

Pre-forming the ceramic member 50 and later attaching it to the substrate 46 rather than forming the ceramic member 50 directly on the substrate 46 has several benefits. For example, using the ceramic bond coat 52 eliminates the need to use metallic braze materials which are detrimental to the mechanical integrity of the substrate 46. The ceramic bond coat 52 also allows other processing techniques to be used in manufacturing a thermal barrier besides or in addition to the coating methods previously used. Furthermore, the ceramic bond coat 52 allows composite architectures having greater thermal resistance to be used as thermal barriers rather than only sprayed coatings that have been used previously. Thus, the structure of the thermal barrier is not limited by the spray/deposition processing technique. It is to be understood that non-composites may also be secured to the substrate according to the disclosed examples.

One example method for manufacturing the thermal barrier system 48 includes pyrolizing a ceramic precursor between the substrate 46 and the ceramic member 50 to form the ceramic bond coat 52 and thereby secure the ceramic member 50 to the substrate 46. As can be appreciated, various additional optional steps may be used to enhance bonding, form additional layers, or the like. The term “pyrolysis” and its variations refer generically to thermal treatments, such as sintering or other thermal processes.

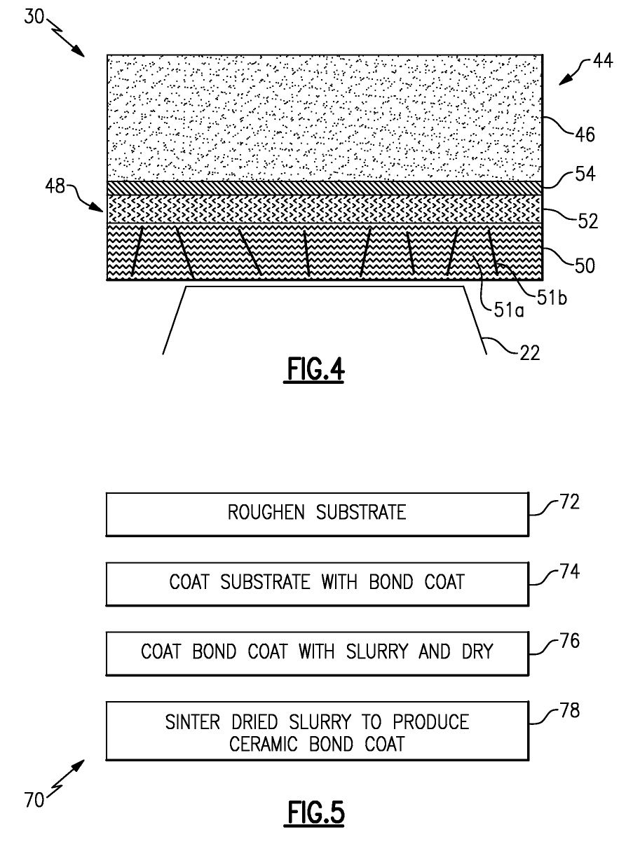

FIG. 5 illustrates one example method 70 that incorporates the pyrolizing step of forming the ceramic bond coat 52. In this example, the substrate 46 is roughened at step 72 and coated at step 74 with the bond coat 54, although in other examples the bond coat 54 may not be used. Roughening the substrate 46 provides the benefit of allowing the bond coat 54 to mechanically interlock with the substrate 46 for enhanced bonding. The bond coat 54 may be deposited onto the substrate 46 in a known manner, such as by cathodic arc deposition, thermal spray, vapor deposition, or other known process.

At step 76, the bond coat 54 is coated with a slurry having a ceramic precursor disbursed within a solvent, such as water, and the ceramic member 50 is placed onto the slurry coating. Alternatively, the slurry is applied to the ceramic member 50 and then placed onto the substrate 46. The slurry infiltrates pores within the ceramic member 50 and pores within the substrate 46 or bond coat 54 such that after pyrolysis the ceramic bond coat 52 mechanically interlocks with the ceramic member 50 and the substrate 46 or the bond coat 54. Optionally, pressure may be applied to compress the ceramic member 50 and the substrate 46 together.

The slurry may be deposited using a process that is suitable for uniformly distributing the slurry. For example, a tape casting method may be used or manual deposition. The slurry is applied with a desired thickness that depends on the pore sizes of the substrate 46 and the ceramic member 50 and desired thickness of the ceramic bond coat 52, for example. That is, less slurry may be required for relatively smaller pores and more slurry may be desired for relatively larger pores. Additionally, less slurry may be used for a relatively thinner ceramic bond coat 52, and more slurry may be used for a relatively thicker ceramic bond coat 52. In one example, the slurry is applied with a thickness of about 10 mils (0.254 mm) or less, which is a suitable amount for infiltrating the pores without forming a thick layer between the substrate 46 and the ceramic member 50 that would increase the overall thickness of the thermal barrier system 48.

In one example, the ceramic precursor of the slurry is a ceramic powder of at least one of the ceramic materials described above. The ceramic powder is later pyrolized to form the ceramic bond coat 52. For example, the slurry includes between about 40 wt % and about 60 wt % of the ceramic powder with a balance being the solvent. In a further example, the slurry includes about 50 wt % of the powder and a balance of the solvent. In some examples, the slurry also includes a polymer binder, such as polyvinyl alcohol in an amount between about 1 wt % and about 30 wt % to increase a viscosity of the slurry. In a further example, the slurry includes about 10 wt % of the polymer binder with a balance of the ceramic powder and the solvent. Alternatively, or instead of the ceramic powder, the slurry may include other types of ceramic precursors that transform during pyrolysis into the ceramic bond coat 52, such as pre-ceramic polymers, partially sintered powders, or inorganic precursors.

After coating the slurry, the slurry is dried to remove the solvent, such as by heating the substrate 46, bond coat 54 (if used), slurry, and ceramic member 50 at a predetermined temperature for a predetermined amount of time. If binder is used, the drying may also include removing the binder, such as by heating at a temperature that melts or decomposes the binder into gaseous products. Optionally, drying and/or binder removal may be incorporated into pyrolizing step 78. After drying and before pyrolysis, the “green” ceramic bond coat may be strong enough, at least in some examples, to secure the ceramic member 50 to the substrate 46. The strength of the “green” ceramic bond coat provides the benefit of holding the substrate 46 and ceramic member 50 together during movement to a subsequent step for further processing, for example. A clamp or the like may additionally be used if greater holding force is desired.

At the pyrolizing step 78, the substrate 46, bond coat 54 (if used), “green” ceramic bond coat, and ceramic member 50 are heated at a predetermined pyrolysis temperature. For example, the pyrolysis temperature is a sintering temperature of the ceramic powder. The ceramic particles density to produce the ceramic bond coat 52, which secures the ceramic member 50 to the substrate 46.

In the disclosed examples, the pyrolysis temperature is below a predetermined threshold temperature to avoid damaging the ceramic member 50 and the substrate 46. For example, above the threshold temperature, the ceramic member 50 may sinter or the substrate 46 (e.g., a nickel alloy) may oxidize. In one example, the threshold temperature is between about 2000° F. (1093° C.) and 2500° F. (1371° C.).

In some examples, the difference between the pyrolysis temperature and the threshold temperature is determined through material selection and/or manufacturing process control. For example, the pyrolysis/sintering temperature of the material selected for the ceramic powder is lower than the sintering temperature of the material(s) selected for the ceramic member 50. Additionally, the size of the powder particles may influence the pyrolysis/sintering temperature. That is, using relatively smaller sized powder particles lowers the pyrolysis/sintering temperature and using relatively larger sized powder particles increases the pyrolysis/sintering temperature. Thus, in some examples, the ceramic material selected for the ceramic bond coat 52 may be the same as the ceramic material selected for the ceramic member 50, but by using relatively small sized powder particles, the pyrolysis/sintering temperature for forming the ceramic bond coat 52 avoids damaging the ceramic member 50.

In one example, the powder particles are nano-sized and comprise a sintering temperature below about 2200° F. (1204° C.), which is below the sintering temperature of the ceramic member 50. The term “nano-sized” refers to an average particle size that is on the order of less than one micrometer. In one example, the nano-sized particles comprise a nominal average size between about 1 nanometer and 100 nanometers.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A composite article comprising:
a substrate;
a ceramic member at least a portion of on the substrate; and
a ceramic bond coat for securing the substrate and the ceramic member together.

2. The composite article as recited in claim 1, wherein the ceramic member has a first pyrolysis temperature and the ceramic bond coat has a second pyrolysis temperature that is less than the first pyrolysis temperature.

3. The composite article as recited in claim 1, wherein the ceramic bond coat includes at least one of zirconia, zirconia silicate, alumina, or mullite.

4. The composite article as recited in claim 1, wherein the substrate comprises a turbine blade outer air seal.

5. The composite article as recited in claim 1, wherein the ceramic member comprises zirconia.

6. The composite article as recited in claim 5, wherein the zirconia comprises yttria stabilized zirconia.

7. The composite article as recited in claim 1, wherein the ceramic member comprises a ceramic matrix composite.

8. The composite article as recited in claim 7, wherein the ceramic matrix composite comprises ceramic reinforcement disbursed within a ceramic matrix.

9. The composite article as recited in claim 8, wherein the ceramic reinforcement includes fibers comprising yttria stabilized zirconia, zirconia, gadolinia, hafnia, or combinations thereof.

10. The composite article as recited in claim 8, wherein the ceramic matrix comprises at least one of yttria stabilized zirconia, hafnia, zirconia, gadolinia, mullite, or alumina.

11. The composite article as recited in claim 1, further comprising a bond coat disposed between the substrate and the ceramic bond coat, wherein the bond coat comprises at least one of nickel, cobalt, iron, chromium, aluminum, or yttrium.

12. The composite article as recited in claim 1, wherein the ceramic member comprises a closed cell ceramic foam.

13. A composite article intermediate comprising:
a substrate;
a ceramic member on the substrate; and
a ceramic precursor between the substrate and the ceramic member.

14. The composite article intermediate as recited in claim 13, wherein the ceramic precursor comprises a thickness of 10 mils or less.

15. The composite article intermediate as recited in claim 13, wherein the ceramic precursor comprises a slurry having ceramic powder disbursed within a solvent.

16. The composite article intermediate as recited in claim 15, wherein the slurry comprises 40 wt % to 60 wt % of the ceramic powder and a balance of the solvent.

17. A composite article intermediate as recited in claim 15, wherein the slurry comprises a polymer binder.

18. The composite article intermediate as recited in claim 17, wherein the polymer binder comprises polyvinyl alcohol.

19. The composite article intermediate as recited in claim 17, wherein the slurry comprises 1 wt % to 30 wt % of the polymer binder and a balance of the ceramic powder and the solvent.

20. The composite article intermediate as recited in claim 19, wherein the slurry comprises about 10 wt % of the polymer binder and the balance of the ceramic powder and the solvent.

21. The composite article intermediate as recited in claim 15, wherein the ceramic powder comprises at least one of zirconia, zirconia silicate, alumina, or mullite.

22. The composite article intermediate as recited in claim 15, wherein the ceramic powder comprises nano-sized powder particles.

23. A method of securing a ceramic member to a substrate, comprising:
(a) pyrolizing a ceramic precursor between the substrate and the ceramic member to form a ceramic bond coat that secures the ceramic member to the substrate.

24. The method as recited in claim 23, wherein said step (a) includes heating at a temperature below a sintering temperature of the ceramic member.

25. The method as recited in claim 23, further comprising, before said step (a), applying a slurry having the ceramic precursor onto the substrate or the ceramic member.

26. The method as recited in claim 25, further comprising removing at least a portion of a solvent within the slurry to produce an intermediate ceramic bond coat.

27. The method as recited in claim 23, further comprising compressing the substrate and the ceramic member together under a pressure.
